(19) United States
(12) Patent Application Publication
(10) Pub. No.: US 2009/0042026 A1
(43) Pub. Date: Feb. 12, 2009

(54) Cold-Workable Laminate for Blister Bottom Parts

(76) Inventor: Erwin Pasbrig, Singen (DE)

Correspondence Address: Fisher Christen & Sabol, 1725 K Street nW Suite 1108, Washington, DC, 20006, US

(21) Appl. No.: 12/083,542

(22) PCT Filed: Oct. 10, 2006
(86) PCT No.: PCT/EP2006/009764

§ 371 Date: Apr. 14, 2008

(30) Foreign Application Priority Data
Oct. 18, 2005 (EP) 05405587.6

(51) Int. Cl. B32B 27/06; B32B 5/00; B65D 65/40; B65D 73/00

(52) U.S. Cl. 428/336; 428/421; 428/337; 206/461; 53/396

(57) ABSTRACT

A cold-formable laminate (10) made of an aluminum foil (14) which is laminated on both sides with plastics material for producing base parts of blister packagings for products which are sensitive to moisture has a plastics material layer arranged on a first side of the aluminum foil (14), as the outer layer (12), and a sealing layer (16) arranged on the second side of the aluminum foil (14) made of a film of polychlorotrifluoroethylene (PCTFE). The laminate is suitable for the production of base parts of blister packagings for products which are sensitive to moisture.

The invention relates to a cold-formable laminate made of an aluminium foil which is laminated on both sides with plastics material for producing base parts of blister packagings for products which are sensitive to moisture, with a plastics material layer arranged on a first side of the aluminium foil, as the outer layer, and a sealing layer arranged on the second side of the aluminium foil.

Cold-formable laminates made of an aluminium foil which is laminated on both sides with plastics material are used inter alia for producing base parts of blister packagings for pharmaceutical products. Wells for receiving individual tablets or other forms of individual doses are formed in the base parts. The aluminium foil is used here primarily as a barrier layer against the penetration of water vapour and gases and protects the products above all from absorbing or giving off moisture.

Conventional laminates for producing base parts of blister packagings for pharmaceutical products frequently have the structure oPA/aluminium foil/sealing layer. Conventional sealing layers consist of 15 to 100 μm PVC, 20-60 μm PP or 30-50 μm PE. After filling the wells, an optionally peelable outer foil is sealed against the base part. Conventional outer foils are optionally aluminium foils which are optionally coated with plastics material, laminated with film or lacquered. In these blister packagings, the products are protected against environmental influences from both sides between two aluminium foils which are arranged as a barrier against the penetration of water vapour and gases.

A blister packaging, however, has unprotected points. After being punched out, the cut edges are exposed and in the case of perforation, the perforation cuts are exposed. The sealing layer is no longer protected at these points by the barrier layer made of aluminium. Over time, moisture diffuses by means of lateral diffusion through the plastics material into the wells and thus shortens the durability of the filling.

More and more active ingredients for medicines and chemicals for diagnostic applications are being developed which have a very high sensitivity to moisture. For products of this type blister packagings with reduced lateral diffusion would be desirable.

Multi-layer films with a barrier layer and with a sealing layer containing material which absorbs moisture are known from WO-A-2004/000541 and WO-A-2004/080808. The films are used for the packaging of items which are sensitive to moisture, such as, for example, diagnostic test strips, and are either hot-sealed after folding against themselves or against a second film. Calcium oxide (CaO) is preferably used as the moisture-absorbing material with strong water binding.

The invention is based on the object of providing a cold-formable laminate of the type mentioned at the outset which is suitable for producing base parts of blister packagings for products which are sensitive to moisture, said laminate having a higher protective effect against the penetration of moisture in the case of lateral diffusion than conventional laminates according to the prior art even without the admixing of materials which absorb moisture to the sealing layer.

The fact that the sealing layer consists of a film made of polychlorotrifluoroethylene (PCTFE) leads to the achievement of the object according to the invention.

The outer layer is preferably a biaxially stretched film made of plastics material.

A first laminate structure according to the invention has the layer sequence outer layer/aluminium foil/sealing layer.

In a second laminate structure according to the invention with the layer sequence outer layer/intermediate layer/aluminium foil/sealing layer, a further preferably biaxially stretched film made of plastics material is arranged, as the intermediate layer, between the outer layer and the aluminium foil.

In a third laminate structure according to the invention with the layer sequence outer layer/aluminium foil/intermediate layer/sealing layer, a further preferably biaxially stretched film made of plastics material is arranged as the intermediate layer between the sealing layer and the aluminium foil.

In a fourth laminate structure according to the invention with the layer sequence outer layer/intermediate layer/aluminium foil/intermediate layer/sealing layer, a further, preferably biaxially stretched film made of plastics material is arranged, in each case, as the intermediate layer, both between the outer layer and the aluminium foil and between the sealing layer and the aluminium foil.

The aluminium foil is in the soft state and preferably has a thickness of 20 to 100 μm, in particular 30 to 60 μm.

The biaxially stretched films made of plastics material preferably have a thickness of 10 to 40 μm, in particular 12 to 40 μm.

The biaxially stretched films may consist of polypropylene (PP), polyester, polyvinylchloride (PVC), polyamide (PA), cycloolefin copolymer (COC) or cycloolefin polymer (COP).

The film made of polychlorotrifluoroethylene (PCTFE) may be unstretched or stretched and preferably has a thickness of 10 to 120 μm, in particular 12 to 105 μm.

The individual layers may be connected by lamination with solvent-based, solvent-free or aqueous adhesives and/or by extrusion lamination. The outer layer or the aluminium foil which is located therebelow may be printed.

A blister base part may be produced in the known manner from the cold-formable laminate. The sealing layer of the laminate in this case forms the inner layer of the blister base part.

In a blister packaging for products which are sensitive to moisture, in particular for pharmaceutical products such as tablets and powders which are sensitive to moisture, an aluminium foil which is optionally coated with plastics material and/or with other materials, laminated with film or lacquered, is sealed against the PCTFE layer of the blister base part in a known manner.

Preferred film/foil combinations for the four laminate structures according to the invention are compiled in Tables 1 to 4. The abbreviations for the plastics materials used as a base for the films signify:

oPA oriented polyamide PET polyethyleneterephthalate
oPP oriented polypropylene PCTFE polychlorotrifluoroethylene

TABLE 1
First laminate structure

| No. | Outer layer | | Al | Sealing layer | |
|---|---|---|---|---|---|
| 1 | 25 | μm oPA | 45 μm | 15 | μm PCTFE |
| 2 | 25 | μm oPA | 60 μm | 15 | μm PCTFE |
| 3 | 25 | μm oPA | 45 μm | 23 | μm PCTFE |
| 4 | 25 | μm oPA | 60 μm | 23 | μm PCTFE |
| 5 | 25 | μm oPA | 45 μm | 51 | μm PCTFE |
| 6 | 25 | μm oPA | 60 μm | 51 | μm PCTFE |
| 7 | 25 | μm oPA | 45 μm | 76 | μm PCTFE |
| 8 | 25 | μm oPA | 60 μm | 76 | μm PCTFE |
| 9 | 25 | μm oPA | 45 μm | 102 | μm PCTFE |
| 10 | 25 | μm oPA | 60 μm | 102 | μm PCTFE |
| 11 | 23 | μm PET | 45 μm | 15 | μm PCTFE |
| 12 | 23 | μm PET | 60 μm | 23 | μm PCTFE |
| 13 | 23 | μm PET | 45 μm | 51 | μm PCTFE |
| 14 | 20 | μm oPP | 60 μm | 15 | μm PCTFE |
| 15 | 20 | μm oPP | 45 μm | 23 | μm PCTFE |
| 16 | 20 | μm oPP | 60 μm | 51 | μm PCTFE |

TABLE 2
Second laminate structure

| No. | Outer layer | | Al | Intermediate layer | | Sealing layer | |
|---|---|---|---|---|---|---|---|
| 17 | 25 | μm oPA | 45 μm | 25 | μm oPA | 15 | μm PCTFE |
| 18 | 25 | μm oPA | 60 μm | 25 | μm oPA | 15 | μm PCTFE |
| 19 | 25 | μm oPA | 45 μm | 25 | μm oPA | 23 | μm PCTFE |
| 20 | 25 | μm oPA | 60 μm | 25 | μm oPA | 23 | μm PCTFE |
| 21 | 25 | μm oPA | 45 μm | 25 | μm oPA | 51 | μm PCTFE |
| 22 | 25 | μm oPA | 60 μm | 25 | μm oPA | 51 | μm PCTFE |
| 23 | 25 | μm oPA | 45 μm | 25 | μm oPA | 76 | μm PCTFE |
| 24 | 25 | μm oPA | 60 μm | 25 | μm oPA | 76 | μm PCTFE |
| 25 | 25 | μm oPA | 45 μm | 15 | μm oPA | 102 | μm PCTFE |
| 26 | 25 | μm oPA | 60 μm | 15 | μm oPA | 102 | μm PCTFE |
| 27 | 23 | μm PET | 60 μm | 23 | μm PET | 15 | μm PCTFE |
| 28 | 23 | μm PET | 60 μm | 23 | μm PET | 23 | μm PCTFE |
| 29 | 23 | μm PET | 60 μm | 23 | μm PET | 51 | μm PCTFE |
| 30 | 23 | μm PET | 45 μm | 23 | μm PET | 76 | μm PCTFE |
| 31 | 23 | μm PET | 60 μm | 23 | μm PET | 76 | μm PCTFE |
| 32 | 23 | μm PET | 45 μm | 23 | μm PET | 102 | μm PCTFE |
| 33 | 23 | μm PET | 60 μm | 23 | μm PET | 102 | μm PCTFE |
| 34 | 20 | μm oPP | 60 μm | 20 | μm oPP | 15 | μm PCTFE |
| 35 | 20 | μm oPP | 60 μm | 20 | μm oPP | 23 | μm PCTFE |
| 36 | 20 | μm oPP | 60 μm | 20 | μm oPP | 51 | μm PCTFE |
| 37 | 20 | μm oPP | 45 μm | 20 | μm oPP | 76 | μm PCTFE |
| 38 | 20 | μm oPP | 60 μm | 20 | μm oPP | 76 | μm PCTFE |
| 39 | 20 | μm oPP | 45 μm | 20 | μm oPP | 102 | μm PCTFE |
| 40 | 20 | μm oPP | 60 μm | 20 | μm oPP | 102 | μm PCTFE |

TABLE 3
Third laminate structure

| No. | Outer layer | Intermediate layer | Al | Sealing Layer |
|---|---|---|---|---|
| 41 | 20 μm oPA | 20 μm oPA | 45 μm | 15 μm PCTFE |
| 42 | 15 μm oPA | 15 μm oPA | 60 μm | 15 μm PCTFE |
| 43 | 20 μm oPA | 20 μm oPA | 45 μm | 23 μm PCTFE |
| 44 | 15 μm oPA | 15 μm oPA | 60 μm | 23 μm PCTFE |
| 45 | 20 μm oPA | 20 μm oPA | 45 μm | 51 μm PCTFE |
| 46 | 15 μm oPA | 15 μm oPA | 60 μm | 51 μm PCTFE |

TABLE 4
Fourth laminate structure

| | | Intermediate | | Intermediate | Sealing |
|---|---|---|---|---|---|
| No. | Outer layer | layer | Al | layer | layer |
| 47 | 20 μm oPA | 20 μm oPA | 45 μm | 15 μm oPA | 15 μm |
| | | | | | PCTFE |
| 48 | 15 μm oPA | 15 μm oPA | 60 μm | 15 μm oPA | 15 μm |
| | | | | | PCTFE |
| 49 | 20 μm oPA | 20 μm oPA | 45 μm | 15 μm oPA | 23 μm |
| | | | | | PCTFE |
| 50 | 15 μm oPA | 15 μm oPA | 60 μm | 15 μm oPA | 23 μm |
| | | | | | PCTFE |
| 51 | 20 μm oPA | 20 μm oPA | 45 μm | 15 μm oPA | 51 μm |
| | | | | | PCTFE |
| 52 | 15 μm oPA | 15 μm oPA | 60 μm | 15 μm oPA | 51 μm |
| | | | | | PCTFE |

Further advantages, features and details of the invention emerge from the following description of preferred embodiments and with the aid of the drawings, in which, schematically:

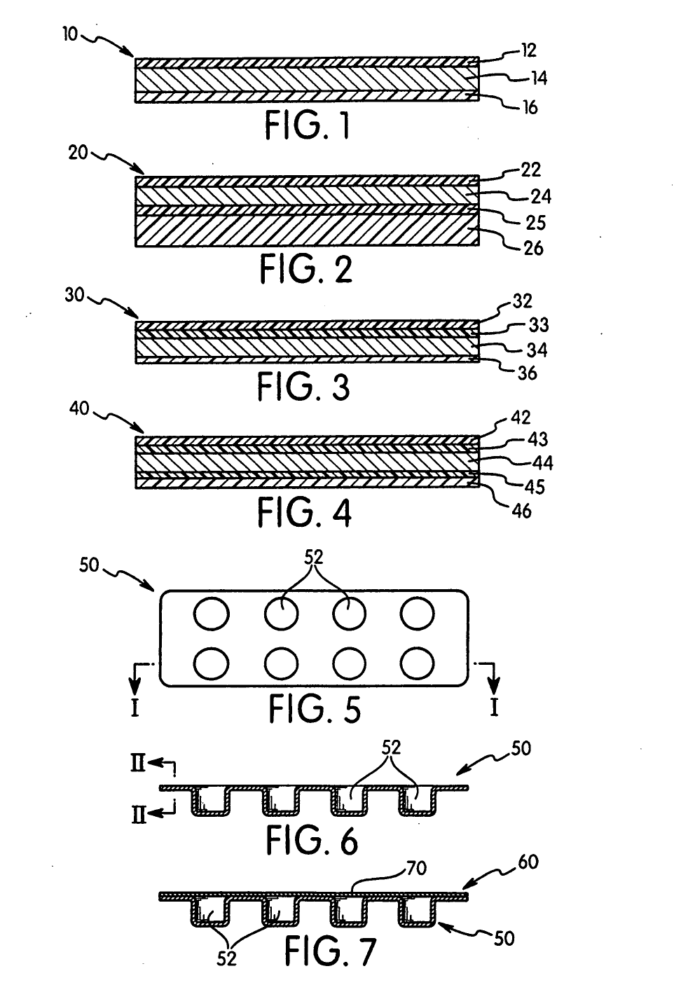

FIG. 1 shows the layer structure of a first cold-formable laminate for the production of blister base parts according to FIG. 5, corresponding to the section line II-II of FIG. 6;

FIG. 2 shows the layer structure of a second cold-formable laminate for the production of blister base parts according to FIG. 5, corresponding to the section line II-II of FIG. 6;

FIG. 3 shows the layer structure of a third cold-formable laminate for the production of blister base parts according to FIG. 5, corresponding to the section line II-II of FIG. 6;

FIG. 4 shows the layer structure of a fourth cold-formable laminate for the production of blister base parts according to FIG. 5, corresponding to the section line II-II of FIG. 6;

FIG. 5 shows the plan view of a blister base part cold-formed from one of the laminates of FIG. 1 to 4;

FIG. 6 shows the section through the blister base part of FIG. 5 along the line I-I;

FIG. 7 shows the blister base part of FIG. 5 with the sealed-on press-through foil or a peelable outer foil.

A first cold-formable laminate 10 for producing base parts for blister packagings for products which are sensitive to moisture, according to FIG. 1, has the following layer structure:
12 outer layer, for example oPA, 25 μm
14 aluminium foil, for example 60 μm
16 sealing layer of PCTFE, for example 23 μm

The oPA film 12 forms the later outer side and the sealing layer 16 the inner side of a blister base part produced from the laminate 10.

A second cold-formable laminate 20 for producing base parts for blister packagings for products which are sensitive to moisture, according to FIG. 2, has the following layer structure:
22 outer layer, for example PET, 23 μm
24 aluminium foil, for example 45 μm
25 intermediate layer, for example PET, 23 μm
26 sealing layer of PCTFE, for example 76 μm

The PET film 22 forms the later outer side and the sealing layer 26 the inner side of a blister base part produced from the laminate 20.

A third cold-formable laminate 30 for producing base parts for blister packagings for products which are sensitive to moisture, according to FIG. 3, has the following layer structure:
32 outer layer, for example oPA, 20 μm
33 intermediate layer, for example oPA, 20 μm
34 aluminium foil, for example 45 μm
36 sealing layer of PCTFE, for example 15 μm

The oPA film 32 forms the later outer side and the sealing layer 36 the inner side of a blister base part produced from the laminate 30.

A fourth cold-formable laminate 40 for producing base parts for blister packagings for products which are sensitive to moisture, according to FIG. 4, has the following layer structure:
42 outer layer, for example oPA, 20 μm
43 intermediate layer, for example oPA, 20 μm
44 aluminium foil, for example 45 μm
45 intermediate layer, for example oPA, 15 μm
46 sealing layer of PCTFE, for example 23 μm

The oPA film 42 forms the later outer side and the sealing layer 46 the inner side of a blister base part produced from the laminate 40.

A blister base part 50 shown in FIG. 5 is produced from the laminate 10, 20, 30, 40, the wells 52 formed from the laminate being formed from the laminate to receive, for example, tablets, by means of cold forming, such as, for example, by deep drawing by means of a die and mould.

As shown in FIGS. 6 and 7, after the filling of the wells 52, a press-through or peelable outer foil 70 is sealed onto the base 50 to form a blister packaging 60, as required.

An outer foil 70 designed as a press-through foil for a blister base part 50 produced from the laminate 10, 20, 30, 40 has, for example, the following layer structure: sealing layer/aluminium foil/print undercoat lacquer/printing/print top lacquer. The printing with the print top lacquer forms the later outer side of the outer foil 70, the free side of the aluminium foil is sealed against the sealing layer of PCTFE of a blister base part 50 produced from the laminate.

An outer foil 70 configured as a peelable foil for a blister base part 50 produced from the laminate 10, 20, 30, 40 has, for example, the following layer structure: aluminium foil/adhesive layer/film made of polyethyleneterephthalate (PET)/adhesive layer/paper/printing/print top lacquer. The printing with the print top lacquer forms the later outer side of the outer foil 70 and the free side of the aluminium foil is sealed against the sealing layer made of PCTFE of a blister base part 50 produced from the laminate.

1. A cold-formable laminate (10, 20, 30, 40) made of an aluminum foil (14, 24, 34, 44) which is laminated on both sides with plastics material for producing base parts (50) of blister packagings (60) for products which are sensitive to moisture, with a plastics material layer arranged on a first side of the aluminum foil (14, 24, 34, 44) as the outer layer (12, 22, 32, 42) and a sealing layer (16, 26, 36, 46) arranged on the second side of the aluminum foil (14, 24, 34, 44), the sealing layer (16, 26, 36, 46) consists of a film made of polychlorotrifluoroethylene (PCTFE).

2. A cold-formable laminate (10, 20, 30, 40) according to claim 1, wherein the outer layer (12, 22, 32, 42) is a biaxially stretched film made of plastics material.

3. A cold-formable laminate (30, 40) according to claim 2, wherein a biaxially stretched film made of plastics material as an intermediate layer (33, 43) is arranged between the outer layer (32, 42) and the aluminum foil (34, 44).

4. A cold-formable laminate (20, 40) according to claim 1, wherein a biaxially stretched film made of plastics material as the intermediate layer (25, 45) is arranged between the aluminum foil (24, 44) and the film (26, 46) made of polychlorotrifluoroethylene (PCTFE).

5. A cold-formable (10, 20, 30, 40) according to claim 1, wherein the aluminum foil (14, 24, 34, 44) has a thickness of 20 to 100 μm.

6. A cold-formable laminate (10, 20, 30, 40) according to claim 2, wherein the biaxially stretched films made of plastics material have a thickness of 10 to 40 μm.

7. A cold-formable laminate (10, 20, 30, 40) according to claim 2, wherein the biaxially stretched films are made of polypropylene (PP), polyester, polyvinylchloride (PVC), polyamide (PA), cycloolefin copolymer (COC), or cycloolefin polymer (COP).

8. A cold-formable laminate (10, 20, 30, 40) according to claim 1, wherein the film (16, 26, 36, 46) made of polychlorotrifluoroethylene (PCTFE) is unstretched or stretched and has a thickness of 10 to 120 μm.

9. A blister base part (50), produced from a the cold-formable laminate (10, 20, 30, 40) according to claim 1.

10. A blister packaging (60) for products which are sensitive to moisture, with a blister base part (50) produced from a the cold-formable laminate (10, 20, 30, 40) according to claim 1 and an outer foil (70) which is sealed against the sealing layer (16, 26, 36, 46) of the laminate on the blister base part (50) and contains an aluminum foil.

11. A process of utilizing the blister packaging (60) according to claim 10 for pharmaceutical products which are sensitive to moisture.

12. The cold-formable laminate (20, 40) according to claim 3, wherein a biaxially stretched film made of plastics material as the intermediate layer (25, 45) is arranged between the aluminum foil (24, 44) and the film (26, 46) made of polychlorotrifluoroethylene (PCTFE).

13. The cold-formable laminate (10, 20, 30, 40) according to claim 12, wherein the aluminum foil (14, 24, 34, 44) has a thickness of 20 to 100 μm.

14. The cold-formable laminate (10, 20, 30, 40) according to claim 12, wherein the biaxially stretched films made of plastics material have a thickness of 10 to 40 μm.

15. The cold-formable laminate (10, 20, 30, 40) according to claim 12, wherein the biaxially stretched films are made of polypropylene (PP), polyester, polyvinylchloride (PVC), polyamide (PA), cycloolefin copolymer (COC), or cycloolefin polymer (COP).

16. The cold-formable laminate (10, 20, 30, 40) according to claim 13, wherein the film (16, 26, 36, 46) made of polychlorotrifluoroethylene (PCTFE) is unstretched or stretched and has a thickness of 10 to 120 μm.

17. The cold-formable laminate (10, 20, 30, 40) according to claim 14, wherein the film (16, 26, 36, 46) made of polychlorotrifluoroethylene (PCTFE) is unstretched or stretched and has a thickness of 10 to 120 μm.

18. The cold-formable laminate (10, 20, 30, 40) according to claim 15, wherein the film (16, 26, 36, 46) made of polychlorotrifluoroethylene (PCTFE) is unstretched or stretched and has a thickness of 10 to 120 μm.

19. A blister base part (50), produced from the cold-formable laminate (10, 20, 30, 40) according to claim 16.

20. A blister base part (50), produced from the cold-formable laminate (10, 20, 30, 40) according to claim 17.

21. A blister base part (50), produced from the cold-formable laminate (10, 20, 30, 40) according to claim 18.

22. A blister packaging (60) for products which are sensitive to moisture, with a blister base part (50) produced from the cold-formable laminate (10, 20, 30, 40) according to claim 19 and an outer foil (70) which is sealed against the sealing layer (16, 26, 36, 46) of the laminate on the blister base part (50) and contains an aluminum foil.

23. A blister packaging (60) for products which are sensitive to moisture, with a blister base part (50) produced from the cold-formable laminate (10, 20, 30, 40) according to claim 20 and an outer foil (70) which is sealed against the sealing layer (16, 26, 36,46) of the laminate on the blister base part (50) and contains an aluminum foil.

24. A blister packaging (60) for products which are sensitive to moisture, with a blister base part (50) produced from the cold-formable laminate (10, 20, 30, 40) according to claim 21 and an outer foil (70) which is sealed against the sealing layer (16, 26, 36, 46) of the laminate on the blister base part (50) and contains an aluminum foil.

25. The cold-formable laminate (10, 20, 30, 40) according to claim 1, wherein aluminum foil (14, 24, 34,44) has a thickness of 30 to 60 μm.

26. The cold-formable laminate (10, 20, 30, 40) according to claim 2, wherein the biaxially stretched films made of plastics material have a thickness of 12 to 40 μm.

27. The cold-formable laminate (10, 20, 30, 40) according to claim 1, wherein the film (16, 26, 36, 46) made of polychlorotrifluoroethylene (PCTFE) is unstretched or stretched and has a thickness of 12 to 105 μm.
